(19) United States
(12) Patent Application Publication
(10) Pub. No.: US 2012/0206783 A1
(43) Pub. Date: Aug. 16, 2012

(54) OPTICAL SCANNING DEVICE

(76) Inventor: Atsushi UEDA, Osaka-shi (JP)

(21) Appl. No.: 13/396,280

(22) Filed: Feb. 14, 2012

(30) Foreign Application Priority Data
Feb. 15, 2011 (JP) 2011-029482

(51) Int. Cl. G02B 26/12; G02B 26/10

(52) U.S. Cl. 359/204.1

(57) ABSTRACT

An optical scanning device has an incident optical system in which optical path lengths from laser diodes to a polygon mirror become longer in the order of the optical path length of the laser beam associated with black, that of the laser beam associated with cyan, that of the laser beam associated with magenta and that of the laser beam associated with yellow. The optical scanning device has an outgoing optical system in which optical path lengths from the polygon mirror to mirrors at which laser beam eclipse occurs become shorter in the order of the optical path length of the laser beam associated with black, that of the laser beam associated with cyan, that of the laser beam associated with magenta and that of the laser beam associated with yellow.

### CROSS REFERENCE

This Nonprovisional application claims priority under 35 U.S.C. §119(a) on Patent Application No. 2011-029482 filed in Japan on Feb. 15, 2011, the entire contents of which are hereby incorporated by reference.

### BACKGROUND OF THE INVENTION

The present invention relates to an optical scanning device for scanning a scan subject with a laser beam from a light source, as well as an image forming apparatus configured to form an electrostatic latent image on an image bearing member as the scan subject by using the optical scanning device.

For example, such an optical scanning device is applied to an image forming apparatus having image bearing members associated with four colors, namely, black (K), cyan (C), magenta (M), and yellow (Y). This type of optical scanning device includes a polygon mirror for reflecting laser beams emitted from light sources associated with the respective colors, and mirrors associated with the respective colors for separating the laser beams reflected by the polygon mirror. The optical scanning device scans the image bearing members associated with the respective colors with the respective laser beams thus separated to form electrostatic latent images thereon (see Japanese Patent Laid-Open Publication No. 2008-26909 for example).

In the optical scanning device described in Japanese Patent Laid-Open Publication No. 2008-26909, a mirror block is disposed at a location spaced a predetermined distance apart from each of the light sources associated with the respective colors. The mirror block has three reflecting surfaces formed on predetermined faces of a block body, and a transmission region formed above the block body. The mirror block distributes laser beams associated with cyan, magenta and yellow to the polygon mirror by reflecting the laser beams by the respective reflecting surfaces while distributing a laser beam associated with black to the polygon mirror by allowing the laser beam to pass through the transmission region directly. The laser beams thus distributed to the polygon mirror are reflected by the polygon mirror, allowed to pass through first to third imaging lenses, and separated by the mirrors associated with the respective colors. The mirrors associated with the respective colors are disposed at locations spaced different distances apart from the polygon mirror to guide the separated laser beams to the respective image bearing members disposed at different locations within size limitations imposed on the image forming apparatus.

In the optical scanning device, the mirror block is an optical component which may incur a mounting position error. When such a mounting position error of the mirror block occurs, deviations occur in the incident angle and the reflection angle of the laser beam emitted from each of the light sources associated with the respective colors with respect to the mirror block, so that the optical path of the laser beam from the light source to the polygon mirror is also deviated. The deviation of the optical path from each of the light source to the polygon mirror causes a deviation to occur in the incident angle and the reflection angle of the laser beam with respect to the polygon mirror. This causes the optical path from the polygon mirror to each of the mirrors associated with the respective colors to deviate. The deviation of the optical path from the polygon mirror to each of the mirrors causes a deviation in the incident position on each mirror, which in turn causes laser beam eclipse to occur. Such laser beam eclipse becomes more conspicuous with increasing deviation in the incident position on each of the mirrors associated with respective colors. The deviation in the incident position on each mirror increases as the optical path length from each light source to the polygon mirror and the optical path length from the polygon mirror to each mirror become longer.

In the optical scanning device described in Japanese Patent Laid-Open Publication No. 2008-26906, the optical path lengths from the light sources associated with the respective colors to the polygon mirror are substantially equal to each other. Accordingly, a longer one of the optical path lengths of the laser beams associated with the respective colors from the polygon mirror to the mirrors associated with the respective colors causes a larger deviation to occur in the incident position on the associated one of the mirrors and, hence, causes more conspicuous laser beam eclipse to occur.

With the foregoing in view, an object of the present invention is to provide an optical scanning device which is capable of preventing laser beam eclipse from occurring conspicuously, as well as an image forming apparatus provided with such an optical scanning device.

### SUMMARY OF THE INVENTION

An optical scanning device according to the present invention includes a plurality of light sources, an optical scanning member, and a plurality of first mirrors. The plurality of light sources are configured to emit respective laser beams. The optical scanning member is configured to scan each of the laser beams from the plurality of light sources in a predetermined direction at a constant velocity. The plurality of first mirrors are disposed at respective locations spaced different distances apart from the optical scanning member and are each configured to reflect a respective one of the laser beams scanned by the optical scanning member toward a scan subject. The plurality of light sources are disposed at respective locations spaced different distances apart from the optical scanning member. The first mirrors are arranged to cause that laser beam which progresses over a longer one of incident optical distances from the light sources to the optical scanning member to progress over a shorter one of outgoing optical distances from the optical scanning member to the first mirrors.

With this configuration, each of the laser beams emitted from the plurality of light sources is scanned by the optical scanning member in the predetermined direction at a constant velocity. The laser beam thus scanned at a constant velocity is reflected by a respective one of the first mirrors to scan over the scan subject. The first mirrors are arranged to cause that laser beam which progresses over a longer one of the incident optical distances from the light sources to the optical scanning member to progress over a shorter one of the outgoing optical distances from the optical scanning member to the first mirrors.

According to another aspect of the present invention, an optical scanning device includes a plurality of light sources, an optical scanning member, a plurality of first mirrors, and a second mirror. The second mirror is disposed between the plurality of light sources and the optical scanning member for reflecting toward the optical scanning member the laser beams which are incident thereon from the plurality of light sources. The first mirrors are arranged to cause that laser beam which progresses over a longer one of incident optical distances from the light sources to the second mirror to progress over a shorter one of outgoing optical distances from the optical scanning member to the first mirrors.

This configuration is provided with the second mirror between the plurality of light sources and the optical scanning member. The second mirror reflects toward the optical scanning member the laser beams which are incident thereon from the plurality of light sources. Since the optical distances over which the laser beams progress from the second mirror to the optical scanning member are equal to each other, the first mirrors are arranged to cause that laser beam which progresses over a longer one of the incident optical distances from the light sources to the second mirror to progress over a shorter one of the outgoing optical distances from the optical scanning member to the first mirrors.

The optical scanning device thus configured enables the incident optical distances from the light sources to the second mirror to be visually recognized easily and hence makes it easy to position the first mirrors to reflect toward respective image bearing members the laser beams which are incident thereon from the light sources.

According to the present invention, it is possible to prevent laser beam eclipse from occurring conspicuously.

### BRIEF DESCRIPTION OF THE DRAWINGS

FIG. 1 is a schematic view showing an image forming apparatus provided with an optical scanning device according to an embodiment of the present invention;

FIG. 2 is a plan view showing the interior of the optical scanning device;

FIG. 3 is a schematic front elevational view of the interior of the optical scanning device;

FIG. 4 is a perspective view showing a relevant portion of the optical scanning device;

FIG. 5 is a plan view of the relevant portion of the optical scanning device;

FIG. 6 is a sectional view taken on line N-N of FIG. 5;

FIG. 7 is a view showing first-half optical paths defined when an error exists in mirror mounting position; and

FIG. 8 is a view showing second-half optical paths defined when the error exists in mirror mounting position.

### DETAILED DESCRIPTION OF THE INVENTION

Hereinafter, an image forming apparatus provided with an optical scanning device according to an embodiment of the present invention will be described.

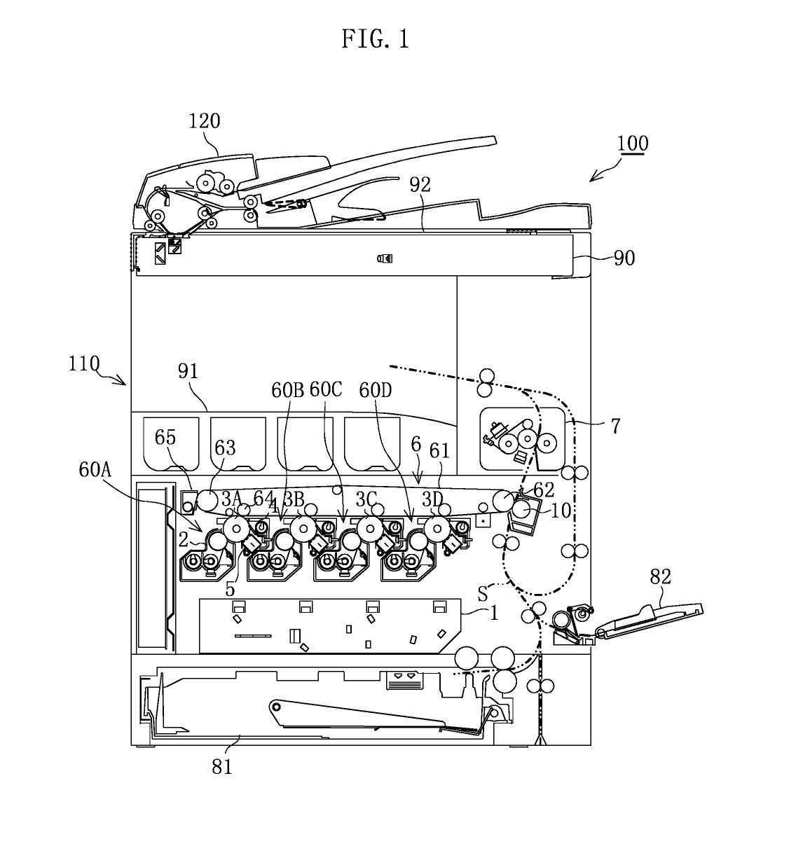

Referring to FIG. 1, an image forming apparatus 100 provided with an optical scanning device 1 according to an embodiment of the present invention is configured to form a polychrome or monochrome image on a predetermined sheet (i.e., recording sheet) in accordance with image data.

The image forming apparatus 100 includes an apparatus body provided at an upper portion thereof with a document platen 92 of transparent glass for placing a document thereon, and an image reading portion 90 configured to read an image of the document placed on the document platen 92. An automatic document processing device 120 is mounted on the upper side of the document platen 92. The automatic document processing device 120 feeds documents onto the document platen 92 automatically. The automatic document processing device 120 is pivotable and allows a document to be manually placed on the document platen 92 by exposing the top surface of the document platen 92.

The apparatus body 110 includes image forming portions 60A to 60D each configured to form a toner image in a respective one of the colors, i.e., black (K), cyan (C), magenta (M) and yellow (Y). The image forming portion 60A includes the optical scanning device 1, a developing device 2, a photoreceptor drum 3, a cleaner unit 4, an electrostatic charger device 5, an intermediate transfer belt unit 6, a fixing unit 7, a sheet feed cassette 81, a sheet output tray 91, and the like. The other image forming portions 60B to 60D are similar in configuration to the image forming portion 60A. The photoreceptor drums of the respective image forming portions 60A to 60D, each of which forms the “scan subject” defined by the present invention, are designated by reference characters 3A to 3D for convenience.

The electrostatic charger device 5 electrostatically charges a peripheral surface of the photoreceptor drum 3 to a predetermined potential uniformly.

The optical scanning device 1 exposes the photoreceptor drum 3 in an electrostatically charged state to light according to the image data inputted, to form an electrostatic latent image on the peripheral surface thereof according to the image data. The developing devices 2 visualize the electrostatic latent images formed on the respective photoreceptor drum 3 by using toners of the four colors: black (K), cyan (C), magenta (M) and yellow (Y). The cleaner unit 4 removes and recovers residual toner remaining on the peripheral surface of the photoreceptor drum 3 after the image transfer operation following the developing operation.

An intermediate transfer belt unit 6 disposed over the photosensitive drums 3 includes an intermediate transfer belt 61, a driving roller 62, an idle roller 63, and intermediate transfer rollers 64. Four intermediate transfer rollers 64 are provided which correspond to the respective colors, i.e., black (K), cyan (C), magenta (M) and yellow (Y).

The driving roller 62, idle roller 63 and intermediate transfer rollers 64 entrain the intermediate transfer belt 61 thereabout to drive the intermediate transfer belt 61 for rotation. The intermediate transfer rollers 64 perform application of transfer bias for transferring the toner images from the photoreceptor drums 3A to 3D onto the intermediate transfer belt 61.

The intermediate transfer belt 61 is positioned so as to come into contact with the photoreceptor drums 3A to 3D. The toner images formed on the respective photoreceptor drums 3A to 3D are transferred onto the intermediate transfer belt 61 so as to be superimposed on one another sequentially, so that a color toner image (polychrome toner image) is formed on the intermediate transfer belt 61. The transfer of the toner images from the photoreceptor drums 3A to 3D to the intermediate transfer belt 61 is achieved by the intermediate transfer rollers 64 in contact with the reverse side of the intermediate transfer belt 61.

The toner image on the intermediate transfer belt 61 is moved by rotation of the intermediate transfer belt 61 to a contact position between a recording sheet to be described later and the intermediate transfer belt 61 and is then transferred onto the recording sheet by the transfer roller 10 disposed at the contact position. Residual toner remaining on the intermediate transfer belt 61 is removed and recovered by an intermediate transfer belt cleaning unit 65.

The sheet feed cassette 81, which is a tray for storing therein sheets to be used for image formation (i.e., recording sheets), is disposed below the optical scanning device 1 of the apparatus body 110. A manual feed cassette 82 can also place thereon a sheet to be used for image formation. A sheet output tray 91 located above the apparatus body 110 is a tray for accumulating thereon sheets finished with printing in a facedown fashion.

The apparatus body 110 is provided with a substantially vertical sheet feed path S for feeding each sheet from the sheet feed cassette 81 or manual feed cassette 82 to the sheet output tray 91 via the transfer roller 10 and fixing unit 7. The fixing unit 7 is located on the sheet feed path S on the downstream side of the transfer roller 10. The fixing unit 7 is configured to fuse, mix and pressure-contact the polychrome toner image transferred to the sheet to fix the toner image onto the sheet by heat.

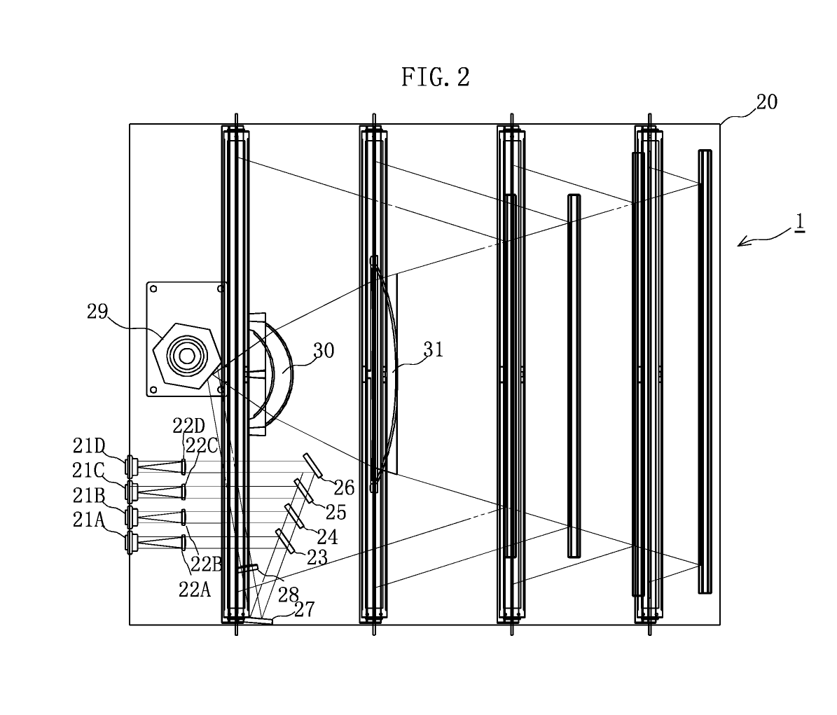

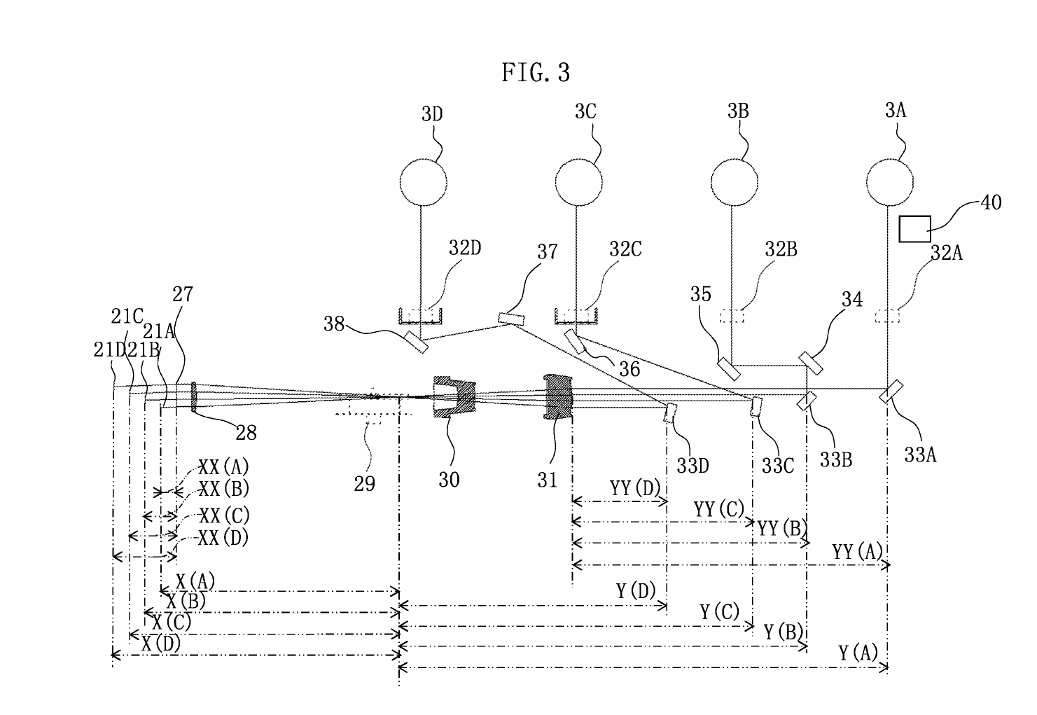

As shown in FIGS. 2 and 3, the optical scanning device 1 has a housing 20 accommodating therein optical components including laser diodes 21A to 21D, collimator lenses 22A to 22D, mirrors 23 to 27, a cylindrical lens 28, a polygon mirror 29, a first fθ lens 30, a second fθ lens 31, third fθ lenses 32A to 32D, mirrors 33A to 33D and 34 to 38. The optical scanning device 1 may employ a technique using a writing head having an array of light-emitting devices of other type such as ELs or LEDs for example. In FIGS. 2 and 3, some of the optical components described above are omitted.

The laser diodes 21A to 21D, which form the “light sources” defined by the present invention, are associated with the respective colors, i.e., black (K), cyan (C), magenta (M) and yellow (Y) and each emit a laser beam modulated according to image data associated with a respective one of these colors.

The collimator lenses 22A to 22D each serve to turn a laser beam emitted from a respective one of the laser diodes 21A to 21D into parallel rays.

The mirrors 23 to 26 deflect the laser beams emitted from the respective laser diodes 21A to 21D toward the mirror 27 (i.e., second mirror). The mirror 27 reflects the laser beams deflected by the mirrors 23 to 26 toward the polygon mirror 29. The cylindrical lens 28 condenses the laser beam outputted from each of the laser diodes 21A to 12D toward a secondary scanning direction only. The mirrors 23 to 27 are disposed between the laser diodes 21A to 21D and the polygon mirror 29.

The polygon mirror 340, which is equivalent to the “optical scanning member” defined by the present invention, scans the laser beams toward a primary scanning direction in a predetermined scanning plane by deflecting the laser beams at an equiangular velocity. To serve the purpose, the polygon mirror 29 is in the form of an equilateral polygonal column having a plurality of reflecting surfaces extending along the periphery thereof and is configured to rotate in a predetermined direction at a constant velocity.

The first fθ lens 30 and the second fθ lens 31 serve to deflect at a constant velocity the laser beams which have been defected at the equiangular velocity by the polygon mirror 29. The third fθ lenses 32A to 32D serve to shape the respective laser beams appropriately and distribute the laser beams to the respective photoreceptor drums 3A to 3D disposed outside the housing 20.

The mirrors (first mirrors) 33A to 33D separate the laser beams deflected by the first and second fθ lenses 30 and 31 from each other, while the mirrors 34 to 38 guide the laser beams thus separated to the respective third fθ lenses 32A to 32D.

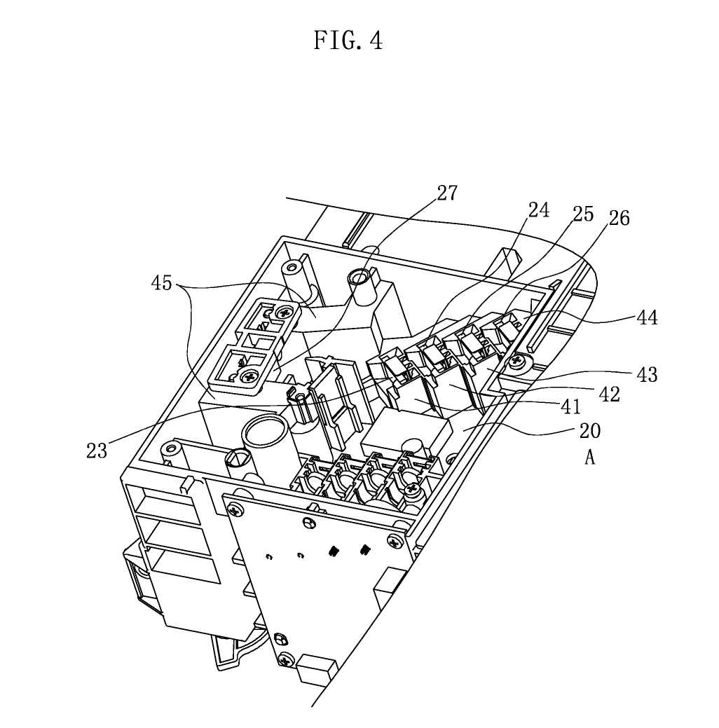

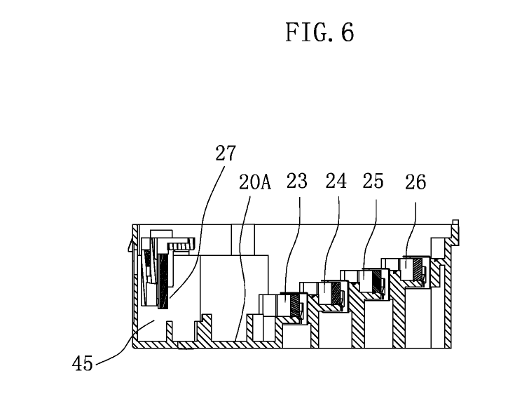

As shown in FIGS. 4 to 6, the mirrors 23 to 27 are held within the housing 20. For this purpose, holding portions 41 to 45 are formed integrally with an internal surface 20A of the housing 20 in such a manner that they stand upright from the internal surface 20A along the normal to the internal surface 20A. The holding portions 41 to 44 hold the mirrors 23 to 26, respectively. The holding portion 45 holds the mirror 27. Besides the holding portions 41 to 45, a multiplicity of holding portions for holding the polygon mirror 29, first to third fθ lenses 30, 31 and 32A to 32D, mirrors 33A to 33D and 34 to 38, and the like are formed integrally with the internal surface 20A.

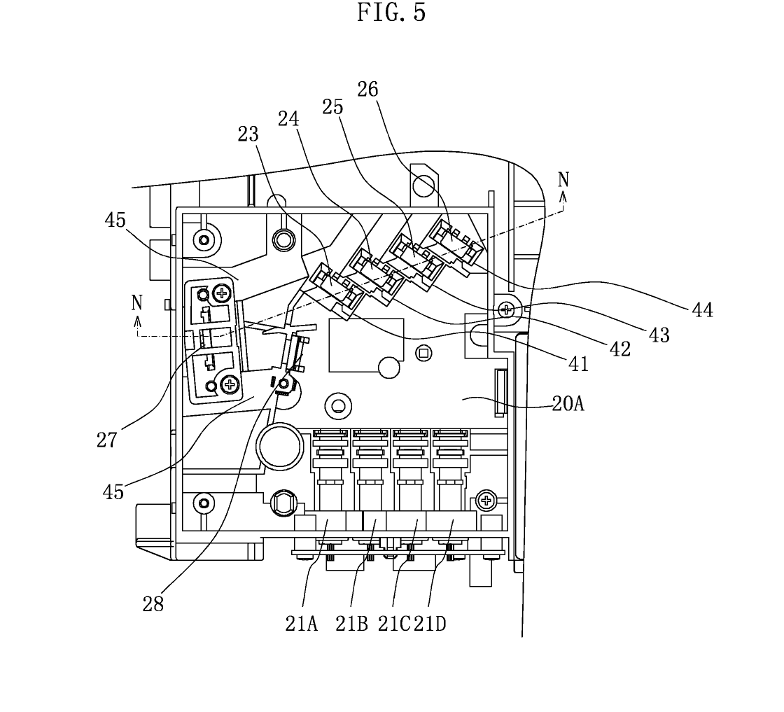

The holding portions 41 to 44 are formed to have gradually increasing extending amounts from the internal surface 20A and hold the mirrors 23 to 26 at different positions in the direction of the normal to the internal surface 20A. Specifically, the mirrors 23 to 26 are arranged stepwise at different positions above the internal surface 20A in the opposite direction away from the mirror 27 so as to be more spaced apart from the internal surface 20A as the distance from the mirror 27 becomes longer, as shown in FIG. 5. The laser beams reflected by the respective mirrors 23 to 26 become incident on the mirror 27 in parallel relation at different positions in the direction of the normal to the internal surface 20A. The mirror 27 reflects the laser beams reflected by the respective mirrors 23 to 26 toward the polygon mirror 29.

The holding portions 41 to 44 have to hold the respective mirrors 23 to 25 so that the laser beams reflected by the mirrors 23 to 25 become incident on the mirror 27. The holding portion 45, on the other hand, has to hold the mirror 27 so that the laser beams reflected by the mirror 27 become incident on the reflecting surfaces of the polygon mirror 29. For this reason, the holding portions 41 to 44 are positioned as spaced predetermined distances apart from the holding portion 45 in such a manner that the holding portions 41 to 44 are opposed to the holding portion 45 at a predetermined angle.

As described above, the optical path lengths of the laser beams associated with the respective colors are different from each other in the incident optical system including the optical paths from the laser diodes 21A to 21D to the polygon mirror 29. Specifically, the optical path length of the laser beam associated with black is the shortest, that of the laser beam associated with cyan is the second shortest, that of the laser beam associated with magenta is the third shortest, and that of the laser beam associated with yellow is the longest.

The mirrors 33A to 33D separate the laser beams reflected by the polygon mirror 29 from each other and then guides the laser beams to the respective photoreceptor drums 3A to 3D arranged side by side near the intermediate transfer belt 61. The mirrors 33A to 33D are disposed below the photoreceptor drums 3A to 3D and spaced different distances apart from the polygon mirror 29 in order to avoid an increase in the vertical dimension of the image forming apparatus 100.

As described above, the optical path lengths of the laser beams associated with the respective colors are different from each other in the outgoing optical system including the optical paths from the polygon mirror 29 to the mirrors 33A to 33D. Specifically, the optical path length of the laser beam associated with black is the longest, that of the laser beam associated with cyan is the second longest, that of the laser beam associated with magenta is the third longest, and that of the laser beam associated with yellow is the shortest.

As shown in FIG. 3, the relation between the optical path lengths of the laser beams associated with the respective colors in the incident optical system and those of the laser beams in the outgoing optical system is as follows.

The optical path lengths of the laser beams associated with black, cyan, magenta and yellow from the laser diodes 21A to 21D to the polygon mirror 29 in the incident optical system are represented by X(A), X(B), X(C) and X(D), respectively. The optical path lengths of the laser beams associated with black, cyan, magenta and yellow from the polygon mirror 29 to the mirrors 33A to 33D in the outgoing optical system are represented by Y(A), Y(B), Y(C) and Y(D), respectively. The optical path lengths of the laser beams associated with the respective colors satisfy the relationships: X(A)<X(B)<X(C)<X(D) and Y(A)>Y(B)>Y(C)>Y(D).

The optical path lengths of the laser beams associated with the respective colors from the mirror 27 to the polygon mirror 29 are equal to each other. The optical path lengths of the laser beams associated with black, cyan, magenta and yellow from the laser diodes 21A to 21D to the mirror 27 are represented by XX(A), XX(B), XX(C) and XX(D), respectively. The optical path lengths of the laser beams associated with the respective colors satisfy the relationships: XX(A)<XX(B)<XX(C)<XX(D) and Y(A)>Y(B)>Y(C)>Y(D).

The optical path lengths of the laser beams associated with the respective colors from the polygon mirror 29 to the second fθ lens 31 are equal to each other. The optical path lengths of the laser beams associated with black, cyan, magenta and yellow from the second fθ lens 31 to the mirrors 33A to 33D are represented by YY(A), YY(B), YY(C) and YY(D), respectively. The optical path lengths of the laser beams associated with the respective colors satisfy the relationships: X(A)<X(B)<X(C)<X(D) and YY(A)>YY(B)>YY(C)>YY(D). Further, the optical path lengths of the laser beams associated with the respective colors satisfy the relationships: XX(A)<XX(B)<XX(C)<XX(D) and YY(A)>YY(B)>YY(C)>YY(D).

In general, the occurrence of an error in the mounting position of an optical component affects the optical scanning device 1 more seriously with increasing optical path length. Specifically, such an error causes the optical path of each laser beam, the angle of incidence of each laser beam on the optical component and the angle of reflection of each laser beam from the optical component to deviate increasingly with increasing optical path length. In the optical scanning device 1, the optical paths of the laser beams associated with the respective colors are set to cause that laser beam which progresses over a longer one of the optical path lengths in the incident optical system to progress over a shorter one of the optical path lengths in the outgoing optical system. By virtue of such setting, the optical scanning device 1 can prevent the optical paths of the laser beams from deviating conspicuously even when an error exists in the mounting position of an optical component.

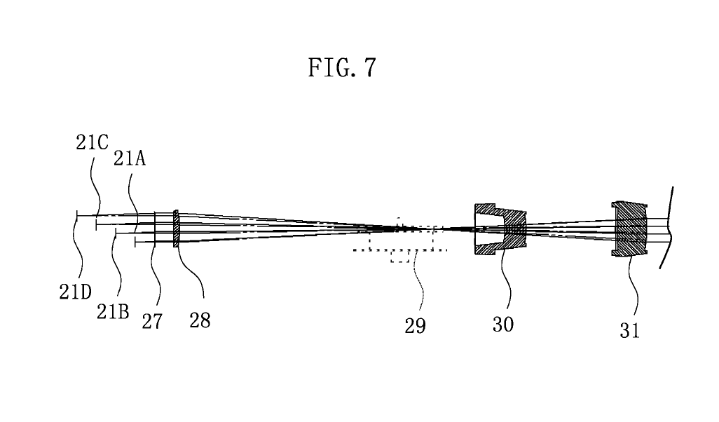

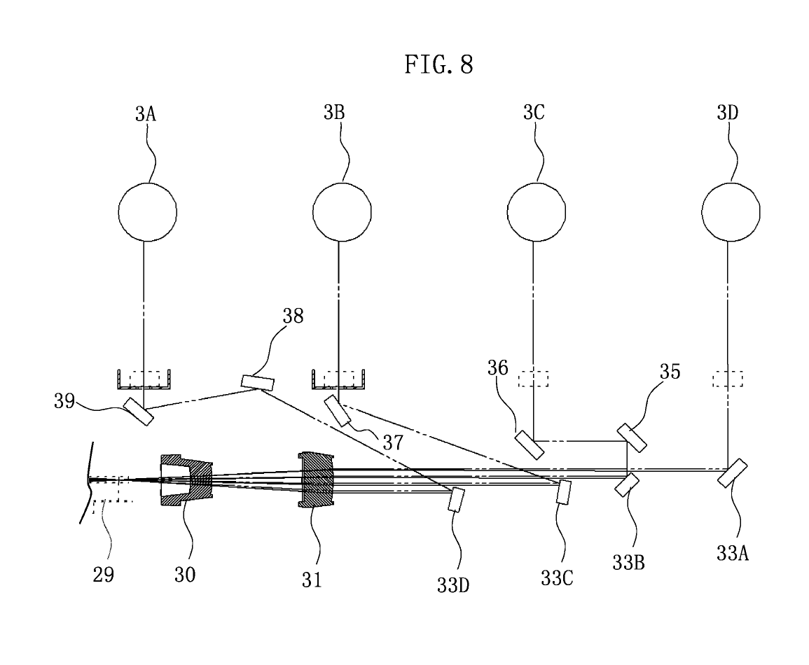

Referring to FIGS. 7 and 8, description is directed to a case where the incident optical system has an error in the mounting position of the mirror 27. In FIGS. 7 and 8, dashed double-dotted lines depict optical paths defined in a case where no error exists in the mounting position of the mirror 27, whereas solid lines depict optical paths defined in the case where an error exists in the mounting position of the mirror 27.

As shown in FIG. 7, each of the laser beams emitted from the laser diodes 21A to 21D have to be in the form of parallel rays upon being incident on the cylindrical lens 28 so that its optical axis passes through the center of the polygon mirror 29.

With an error in the mounting position of the mirror 27, the reflecting surface of the mirror 27 is tilted and, hence, the laser diodes 21A to 21D have to emit the laser beams so that each of the laser beams becomes incident on the mirror 27 at a varied incident angle. A longer one of the optical path lengths from the laser diodes 21A to 21D to the mirror 27 causes a larger deviation in the angle of incidence of the laser beam on the mirror 27 and, hence, the associated one of the laser diodes has to vary the emission angle more largely in emitting the laser beam.

Each of the laser beams emitted from the respective laser diodes 21A to 21D at the emission angle thus varied is led to the polygon mirror 29 in such a manner that its optical axis passes through the center of the polygon mirror 29. Deviations occur in the angle of incidence of each laser beam on the polygon mirror 29 and the angle of reflection of each laser beam from the polygon mirror 29. Such deviations become larger with increasing change in the emission angle from each of the laser diodes 21A to 21D. That is, a longer one of the optical path lengths from the laser diodes 21A to 21D to the mirror 27 causes larger deviations to occur in the angle of incidence and the angle of reflection with respect to the polygon mirror 29. More exactly, since the optical path lengths of the laser beams from the mirror 27 to the polygon mirror 29 are equal to each other while the optical path lengths from the laser diodes 21A to 21D to the mirror 27 are different from each other, a longer one of the optical path lengths from the laser diodes 21A to 21D to the mirror 27 causes larger deviations to occur in the incident angle and the reflection angle with respect to the polygon mirror 29.

As shown in FIG. 8, in the outgoing optical system the position of incidence of each laser beam on a respective one of the mirrors 33A to 33D deviates more largely as the deviation in the reflection angle of the laser beam reflected from the polygon mirror 29 becomes larger.

Further, with the deviation in the reflection angle from the polygon mirror 29, a longer one of the optical path lengths of the respective laser beams from the polygon mirror 29 to the mirrors 33A to 33D causes a larger deviation to occur in the incident position on the associated one of the mirrors 33A to 33D. More exactly, since the optical path lengths of the laser beams from the polygon mirror 29 to the second fθ lens 31 are equal to each other while the optical path lengths from the second fθ lens 31 to the mirrors 33A to 33D are different from each other, a longer one of the optical path lengths from the second fθ lens 31 to the mirrors 33A to 33D causes a larger deviation to occur in the incident position on the associated one of the mirrors 33A to 33D.

Such a deviation in the incident position on each of the mirrors 33A to 33D causes laser beam eclipse to occur because the deviation prevents each laser beam from being totally reflected by a respective one of the mirrors 33A to 33D.

The laser beams reflected by the respective mirrors 33A to 33D become incident on the respective mirrors 34 to 38. For this reason, laser beam eclipse occurs at the mirrors 34 to 38 also. However, the laser beam eclipse at the mirrors 33A to 33D is more conspicuous than that at the mirrors 34 to 38.

As described above, the optical paths of the respective laser beams are set to cause that laser beam which progresses over a longer one of the optical path lengths in the incident optical system to progress over a shorter one of the optical path lengths in the outgoing optical system. Accordingly, that laser beam which incurs a larger deviation in the incident position on the associated one of the mirrors 33A to 33D in the incident optical system incurs a smaller deviation in the incident position on the associated one of the mirrors 33A to 33D in the outgoing optical system. By virtue of such setting, the optical scanning device 1 can prevent a deviation in the incident position of each laser beam on a respective one of the mirrors 33A to 33D from becoming conspicuously large, thereby preventing laser beam eclipse from occurring conspicuously.

In the optical scanning device 1, the sum of the optical path length of the laser beam associated with black in the incident optical system and that in the outgoing optical system is set to the largest of the total optical path lengths of the laser beams associated with the respective colors in the incident and outgoing optical systems. The optical scanning device 1 is provided with BD sensors 40 for detecting the laser beam associated with black. The BD sensors 40 are located at opposite ends of a predetermined range of scanning over the photoreceptor drum 3A by the laser beam associated with black to detect passage of the laser beam.

Based on the result of detection by the BD sensors 40, the optical scanning device 1 can determine whether or not the optical paths of the laser beams associated with the respective colors are deviated. This is because when the optical path of the laser beam associated with black is deviated, it is highly possible that the optical paths of the other laser beams associated with the other colors are also deviated. Since the sum of the optical path length of the laser beam associated with black in the incident optical system and that in the outgoing optical system is the largest, the optical path of the laser beam associated with black is likely to deviate more conspicuously than those of the other laser beams associated with the other colors. For this reason, the optical scanning device 1 can easily determine whether or not the optical paths are deviated. Further, the laser beam associated with black is used more frequently than the other laser beams. Therefore, the optical scanning device 1 can frequently detect whether or not the optical paths are deviated.

Based on the result of detection by the BD sensors 40, the optical scanning device 1 can perform functions including displaying an error message informing the user of the occurrence of optical path deviation of the laser beams and changing the scanning velocity of the laser beams. For example, when the BD sensors 40 fail to detect the laser beam, the optical scanning device 1 causes a display portion (not illustrated) of the image forming apparatus 100 to display an error message informing the user of the occurrence of an error in the optical scanning device 1. Therefore, the image forming apparatus 100 allows the user to easily determine whether a malfunction of the image forming portions 60A to 60D or a malfunction of the optical scanning device 1 is the cause of an image failure.

The foregoing embodiments are illustrative in all points and should not be construed to limit the present invention. The scope of the present invention is defined not by the foregoing embodiments but by the following claims. Further, the scope of the present invention is intended to include all modifications within the scopes of the claims and within the meanings and scopes of equivalents.

What is claimed is:

1. An optical scanning device comprising:
a plurality of light sources configured to emit respective laser beams;
an optical scanning member configured to scan each of the laser beams from the plurality of light sources in a predetermined direction at a constant velocity; and
a plurality of first mirrors disposed at respective locations spaced different distances apart from the optical scanning member and each configured to reflect a respective one of the laser beams scanned by the optical scanning member toward a scan subject,
the light sources being disposed at respective locations spaced different distances apart from the optical scanning member,
the first mirrors being arranged to cause that laser beam which progresses over a longer one of incident optical distances from the light sources to the optical scanning member to progress over a shorter one of outgoing optical distances from the optical scanning member to the first mirrors.

2. The optical scanning device according to claim 1, wherein:
the optical scanning member includes a polygon mirror configured to deflect at an equiangular velocity the laser beams which become incident thereon from the plurality of light sources;
a lens is further provided for deflecting at a constant velocity the laser beams deflected by the polygon mirror; and
the plurality of first mirrors are mirrors on which the laser beams deflected by the lens become incident first.

3. The optical scanning device according to claim 1, further comprising detection means configured to detect the laser beam emitted from that light source from which the sum of the incident optical distance and the outgoing optical distance is longest.

4. The optical scanning device according to claim 1, which scans the laser beams over a plurality of scan subjects each adapted for a respective one of different colors, wherein:
the plurality of light sources are configured to emit the respective laser beams each associated with a respective one of the different colors; and
the plurality of first mirrors are arranged to guide the laser beams from the plurality of light sources to the respective scan subjects adapted for the different colors associated with the respective laser beams.

5. An optical scanning device comprising:
a plurality of light sources configured to emit respective laser beams;
an optical scanning member configured to scan each of the laser beams from the plurality of light sources in a predetermined direction at a constant velocity;
a plurality of first mirrors disposed at respective locations spaced different distances apart from the optical scanning member and each configured to reflect a respective one of the laser beams scanned by the optical scanning member toward a scan subject; and
a second mirror disposed between the plurality of light sources and the optical scanning member for reflecting toward the optical scanning member the laser beams which are incident thereon from the plurality of light sources,
the light sources being disposed at respective locations spaced different distances apart from the optical scanning member,
the first mirrors being arranged to cause that laser beam which progresses over a longer one of incident optical distances from the light sources to the second mirror to progress over a shorter one of outgoing optical distances from the optical scanning member to the first mirrors.

6. The optical scanning device according to claim 5, wherein:
the optical scanning member includes a polygon mirror configured to deflect at an equiangular velocity the laser beams which become incident thereon from the plurality of light sources;
a lens is further provided for deflecting at a constant velocity the laser beams deflected by the polygon mirror; and
the plurality of first mirrors are mirrors on which the laser beams deflected by the lens become incident first.

7. The optical scanning device according to claim 5, further comprising detection means configured to detect the laser beam emitted from that light source from which the sum of the incident optical distance and the outgoing optical distance is longest.

8. The optical scanning device according to claim 5, which scans the laser beams over a plurality of scan subjects each adapted for a respective one of different colors, wherein:
the plurality of light sources are configured to emit the respective laser beams each associated with a respective one of the different colors; and
the plurality of first mirrors are arranged to guide the laser beams from the plurality of light sources to the respective scan subjects adapted for the different colors associated with the respective laser beams.

9. An image forming apparatus comprising an optical scanning device as recited in claim 1.

10. An image forming apparatus comprising an optical scanning device as recited in claim 5.
